(19) United States
(12) Patent Application Publication
(10) Pub. No.: US 2018/0361978 A1
(43) Pub. Date: Dec. 20, 2018

(54) VEHICLE AIRBAG

(71) Applicant: Ford Global Technologies, LLC, Dearborn, MI (US)

(72) Inventors: Jamel E. Belwafa, Ann Arbor, MI (US); Pieter Christopher van Ast, Koln (DE)

(73) Assignee: Ford Global Technologies, LLC, Dearborn, MI (US)

(21) Appl. No.: 15/627,874

(22) Filed: Jun. 20, 2017

(51) Int. Cl. B60R 21/16; B60R 21/015

(52) U.S. Cl. CPC B60R 21/16; B60R 21/017; B60R 21/01512

(57) ABSTRACT

An airbag includes an impact panel defining an inflation chamber. The airbag includes a first and a second extension spaced from each other. Each extension has a first portion and a second portion extending transversely to the impact panel. The first portions face each other. The first portions face in a direction transverse to the second portions. A connection member extends from the second portion of the first extension to the second extension.

### BACKGROUND

Vehicles may include a variety of airbags deployable during vehicle impacts to absorb energy from occupants of the vehicles during the impact. The airbag may be a component of an airbag assembly including a housing supporting the airbag, and an inflator in communication with the airbag for inflating the airbag from an uninflated position to an inflated position. The airbag assemblies may be supported on a steering wheel of the vehicle, an instrument panel of the vehicle, a headliner of the vehicle, etc.

### BRIEF DESCRIPTION OF THE DRAWINGS

FIG. 1 is a perspective view of a vehicle including an airbag assembly supported by an instrument panel with an airbag of the airbag assembly in an uninflated position.

FIG. 2 is a perspective view of the vehicle including the airbag in an inflated position and supported by the vehicle.

FIG. 2A is a perspective view of the vehicle including another embodiment of the airbag in an inflated position and supported by the vehicle.

FIG. 3 is a perspective view of another embodiment of the airbag in the inflated position.

FIG. 4 is a perspective view of another embodiment of the airbag in the inflated position.

FIG. 5 is a perspective view of another embodiment of the airbag in the inflated position.

FIG. 6 is a perspective view of another embodiment of the airbag in the inflated position.

FIG. 6A is a cross-section view of an airbag assembly with the airbag of FIG. 6 in the inflated position.

FIG. 6B is a cross-section view of an airbag assembly with another embodiment of the airbag in the inflated position.

FIG. 7 is a perspective view of the airbag of FIG. 2.

FIG. 8 is a perspective view of another embodiment of the airbag in the inflated position.

FIG. 9 is a schematic of an impact sensing system of the vehicle.

### DETAILED DESCRIPTION

An airbag includes an impact panel defining an inflation chamber. The airbag includes a first and a second extension spaced from each other. Each extension has a first portion and a second portion extending transversely to the impact panel. The first portions face each other. The first portions face in a direction transverse to the second portions. A connection member extends from the second portion of the first extension to the second extension.

The connection member may include a first end secured to the second portion of the first extension and a second end secured to the second extension.

The connection member may be spaced from the impact panel.

Each of the first and second extension may include a proximate end and a distal end. The connection member may extend from the proximate end of the first extension to the distal end of the second extension.

The connection member may define a second inflation chamber in communication with the inflation chamber.

The second inflation chamber may be spaced from the impact panel.

The connection member may include at least one tether.

The connection member may include a plurality of tethers.

The tethers may be spaced from each other.

The tethers may be parallel with each other.

The connection member may include a first and a second tether. The first tether may extend from the proximate end of the first extension to the distal end of the second extension. The second tether may extend from the distal end of the first extension to the proximate end of the second extension.

The connection member may be a panel. The panel may extend at least part way between the proximate ends and the distal end of extensions.

The panel may be free of openings.

The panel may define an opening.

The connection member may be exterior to the inflation chamber.

A vehicle includes an impact panel defining an inflation chamber. The vehicle includes a first and a second extension spaced from each other. Each extension has a top portion extending from the impact panel transversely to the impact panel. A connection member extends from the top portion of the first extension to the second extension.

Each extension may have a bottom portion extending from the impact panel transversely to the impact panel. The top portion may be spaced from the bottom portion in a vehicle longitudinal direction.

Each extension may be elongated between the top portion and the bottom portion.

Each extension may include a bottom portion and an inward facing portion. The inward facing portions may face each other. The inward facing portions may separate the top portions from the bottom portions.

The connection member may be exterior to the inflation chamber.

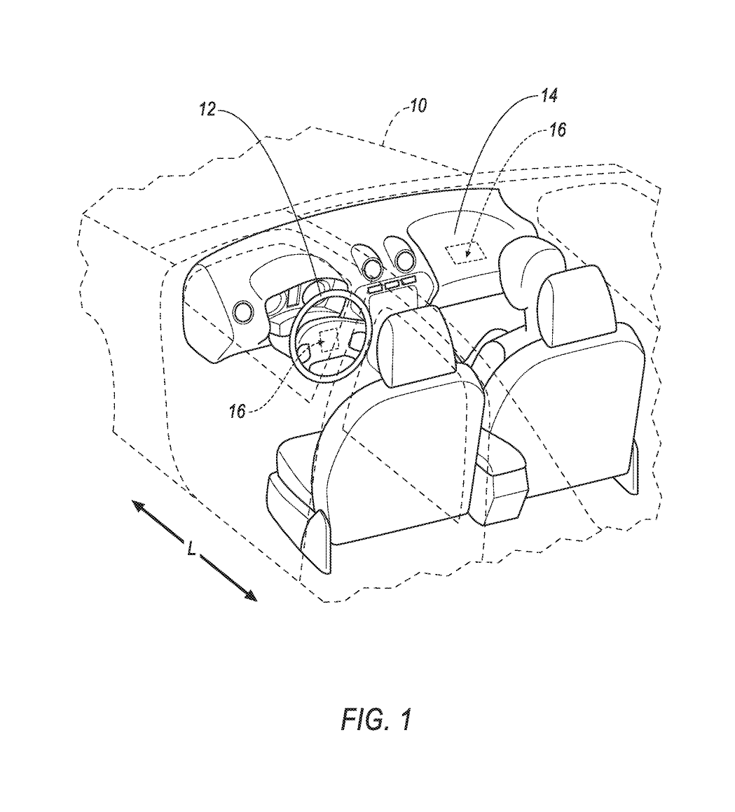

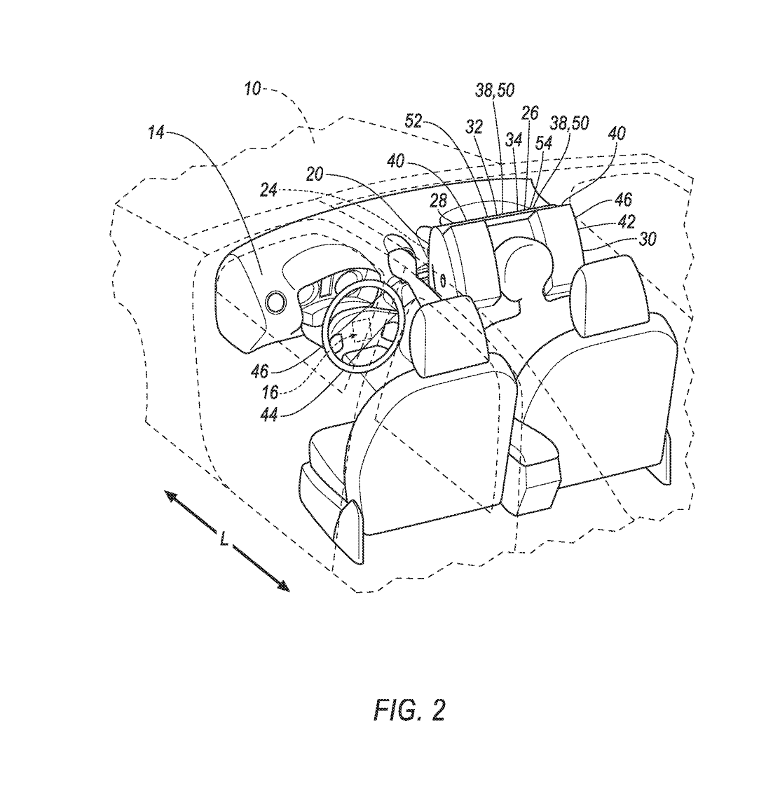

With reference to the Figures, wherein like numerals indicate like parts throughout the several views, an airbag 20 includes an impact panel 26 defining an inflation chamber 24 and is inflatable from an uninflated position, as shown in FIG. 1, to an inflated position, as shown in FIGS. 2-8. The airbag 20 includes a first and a second extension 28, 30 spaced from each other. Each extension 28, 30 has a first portion 38 and a second portion 40 extending transversely to the impact panel 26. The first portions 38 face each other. The first portions 38 face in a direction transverse to the second portions 40. The airbag 20 includes a connection member 32 extending from the second portion 40 of the first extension 28 to the second extension 30.

With reference to FIGS. 1, 2 and 2A, a vehicle 10 may include a steering wheel 12 and/or may include an instrument panel 14. For example, the instrument panel 14 may support the steering wheel 12. The steering wheel 12 and the instrument panel 14 may be positioned at a vehicle-forward end of an occupant compartment (not numbered) of the vehicle 10. The vehicle 10 may be, for example, any type of passenger automobile.

With continued reference to FIGS. 1, 2 and 2A, the vehicle 10 includes an airbag assembly 16, i.e., an airbag module. The airbag assembly 16 may be supported by, for example, the instrument panel 14, as shown in FIGS. 1, 2 and 2A. For example, the airbag assembly 16 may be a passenger airbag assembly as shown in FIG. 2. For example, the airbag assembly 16 may be a driver airbag assembly as shown in FIG. 2A, e.g., the airbag assembly 16 may be supported by the steering wheel 12. As other examples, the airbag assembly 16 may supported by a seat back (not numbered), a headliner (not numbered), etc. Alternatively, the airbag assembly 16 may be supported by any suitable component of the vehicle to absorb impact from any occupant.

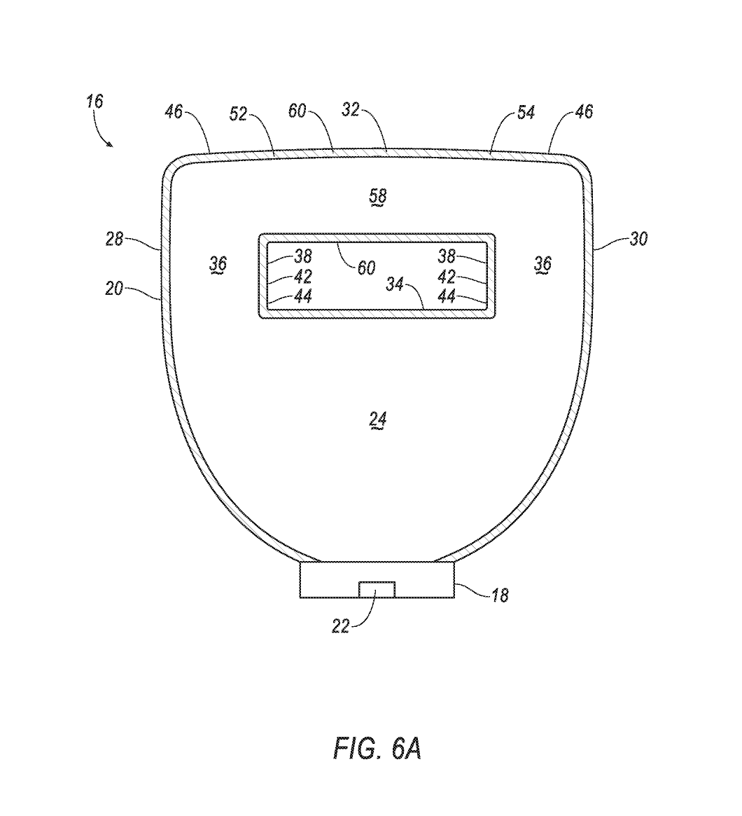

With reference to FIGS. 6A and 6B, the airbag assembly 16 may include a housing 18, and the airbag 20 may be supported by the housing 18. The airbag 20 may be disposed in the housing 18 in an uninflated position, e.g., the housing 18 may define a cavity that houses the airbag 20 in the uninflated position. The housing 18 provides a reaction surface for the airbag 20 in the inflated position. The housing 18 may be supported by, for example, the steering wheel 12, the instrument panel 14, the headliner, one of the seats, etc. The housing 18 may be formed of any material, e.g., a rigid polymer, a metal, a composite, etc.

The airbag assembly 16 may include an inflator 22. The inflator 22 may be in communication with the inflation chamber 24. The inflator 22 may be supported by the housing 18.

The airbag 20, including the impact panel 26, the pair of extensions 28, 30, and the connection member 32, may be formed of a woven polymer or any other suitable material. As one example, the airbag 20 may be formed of woven nylon yarn, for example, nylon 6-6. Other examples include polyether ether ketone (PEEK), polyetherketoneketone (PEKK), polyester, etc. The woven polymer may include a coating, such as silicone, neoprene, urethane, etc. For example, the coating may be polyorgano siloxane.

With reference to FIGS. 2-8, the airbag 20 includes the impact panel 26. In the inflated position, the impact panel 26 may be, for example, a bulbous shape, a spherical shape, a rectangular shape, or any other suitable shape. The impact panel 26 defines the inflation chamber 24. Specifically, the impact panel 26 extends around the inflation chamber 24. The impact panel 26 has multiple sides that extend from the housing 18 in a vehicle-rearward direction and extend in front of the occupant in a cross-vehicle direction. The sides of the impact panel 26 extend around the inflation chamber 24. The impact panel 26 may be a single sheet of material or may be multiple sheets of material connected together, e.g., by stitching.

The impact panel 26 includes a front face 34 that faces the occupant when the airbag 20 is inflated. The front face 34 is disposed between the housing 18 and the connection member 32 when the airbag 20 is inflated. The rest of the impact panel 26 extends from the front face 34 toward the housing 18, i.e., the impact panel 26 changes direction from the front face 34 toward the housing 18. The front face 34 may be generally flat, i.e., is flat or includes a slight curve resulting from the inflation of the airbag 20 and the pliable material type of the impact panel 26. As another example, the front face 34 may be curved, may include rounded portions, etc.

With continued reference to FIGS. 2-8, the airbag 20 includes the first and second extensions 28, 30. Each of the extensions 28, 30 may define an inflatable extension chamber 36. The extensions 28, 30 extend from the front face 34. The extensions 28, 30 are spaced from each other. For example, the front face 34 may extend between the extensions 28, 30. The extensions 28, 30 may have an identical size and shape, as shown in the Figures. Alternatively, the extensions 28, 30 may be shaped differently from each other. The extensions 28, 30 may increase in width the further they extend from the front face 34. The extensions 28, 30 may decrease in width the further they extend from the front face 34. A transition from the front face 34 to the extensions 28, 30 may be angular or may be rounded.

As set forth above, each extension 28, 30 may include the first portion 38 and the second portion 40. The first portion 38 and the second portion 40 extend transversely to the impact panel 26. In particular, the first portion 38 and the second portion 40 of the extensions 28, 30 extend transversely from the front face 34. The first portion 38 and the second portion 40 of the extensions 28, 30 may extend perpendicular from the front face 34. The first portion 38 and the second portion 40 of the extensions 28, 30 may extend other than perpendicular from the front face 34. A transition from the first portion 38 and second portion 40 to the impact panel 26 may be angular or may be rounded.

The first portions 38 face each other. For example, the first portions 38 may each include an outer surface 42, i.e., outside of the respective extension chamber 36. The outer surfaces 42 of the first portions 38 face each other, i.e., a vector extending normally from one of the outer surfaces 42 is pointed at the other of the outer surfaces 42.

The first portions 38 face in a direction transverse to the second portions 40. An extending plane of the first portion 38 may be perpendicular to an extending plane of the second portion 40. An intersection of the first portion 38 with the second portion 40 may be angular or may be rounded.

Each of the first and second extension 28, 30 may include a proximate end 44 and a distal end 46. On each extension 28, 30, the proximate end 44 is spaced from and opposite the distal end 46. The proximate end 44 may abut the impact panel 26. The distal end 46 is spaced from the impact panel 26. The distal ends 46 may be flat as shown, or may be rounded.

The extensions 28, 30 may be in fluid communication with the inflation chamber 24. In other words, the inflation chamber 24 may extend into the extensions 28, 30. For example, the inflation chamber 24 may be open to the extensions 28, 30 (see FIG. 6A). Alternatively, for example, a vent 45 may be disposed in the inflation chamber 24 at the extensions 28, 30 for controlling gas flow into the extensions 28, 30. For example, as shown in FIG. 6B, the vent 45 may be a one-way vent. As other examples, the vent 45 may be an open vent, a two-way vent, an active vent, etc. As another example, the extensions 28, 30 may be separated from the inflation chamber 24, i.e., the extensions 28, 30 may not be in fluid communication with the inflation chamber 24.

With reference to FIGS. 2 and 2A, when the airbag 20 is installed in the vehicle 10 and is in the inflated condition, the second portions 40 are at a top of the extensions 28, 30, i.e., are top portions.

The extensions 28, 30 of the airbag 20 of the vehicle 10 may each include a bottom portion 48. The bottom portions 48 extend from the impact panel 26 transversely to the impact panel 26. The bottom portions 48 of each of the extensions 28, 30 extend transversely from the front face 34. The bottom portions 48 may be located at a bottom of their relative the extensions 28, 30.

The extensions 28, 30 of the airbag 20 of the vehicle 10 each include an inward facing portion 50. The inward facing portions 50 face each other, as described above for the first portions 38. The inward facing portions 50 separate the second portions 40 from the bottom portions 48. In particular, the second portions 40 and bottom portions 48 may be located at opposite ends of the inward facing portions 50. The inward facing portions 50 may extend between the second portions 40 and bottom portions 48 in a direction that is both vertical and longitudinal relative to the vehicle 10 such that the second portions 40 are closer to a front of the vehicle 10 than the bottom portions 48, or vice versa. Accordingly, the second portions 40 may be spaced from the bottom portion 48 in the vehicle 10 longitudinal direction L.

Each of the extensions 28, 30 may be elongated between the second portion 40 and the bottom portion 48. The elongation may be provided by the inward facing portions 50 having a length that is greater than a width of the top and bottom portions 47, 48.

As set forth above, and with reference to FIGS. 2-8, the airbag 20 includes the connection member 32. The connection member 32 connects the first extension 28 and the second extension 30 to position the first extension 28 and the second extension 30 relative to each other during inflation of the airbag 20 and during impact by an occupant. Specifically, the head of the occupant is received between the first extension 28 and the second extension 30, and the connection member 32 holds the first extension 28 and the second extension 30 together. For example, during an impact of the vehicle that causes the occupant to move forward and in a cross-vehicle direction, e.g., an oblique impact, an offset front impact, a small-offset rigid barrier (SORB) test, etc., the head of the occupant may push against one of the extensions 28, 30, and the connection member 32 transfers forces from the impacted extension to the other extension to assist in retaining the reinforcing the impacted extension.

The connection member 32 extends from the second portion 40 of the first extension 28 to the second extension 30. For example, as shown in the Figures, the connection member 32 may extend from the second portion 40 of the first extension 28 to the second portion 40 of the second extension 30. As another example, the connection member 32 may extend from the second portion 40 of the first extension 28 to any suitable component of the airbag 20, i.e., any suitable surface of the second extension 28, the impact panel 26, etc.

The connection member 32 may include a first end 52 and a second end 54. The first end 52 is opposite the second end 54. The first end 52 and second end 54 may be at opposing distal ends of the connection member 32. The first end 52 of the connection member 32 may be secured to the second portion 40 of the first extension 28 and the second end 54 of the connection member 32 may be secured to the second extension 26, e.g., the second portion 40 of the second extension 30.

The connection member 32 may be exterior to the inflation chamber 24 and may be exterior to the extension chambers 36.

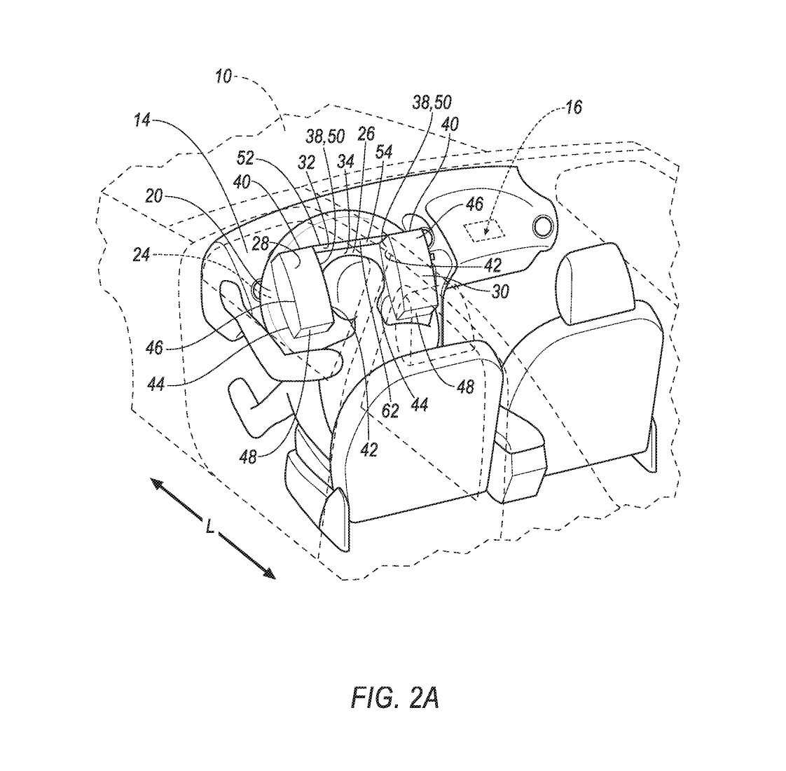

Various examples of the connection member 32 are shown in FIGS. 3-8. As set forth further below, the connection member 32 may include one or more tethers 56, and/or one or more panels 62, and/or may be inflatable and connected to the inflation chamber 24 and/or the extension chambers 36. The connection member 32 may be spaced from the impact panel 26, i.e., the connection member 32 may be positioned to be free from contact with the impact panel 26 in the inflated position. Alternatively, or in addition to being spaced from the impact panel 26, the connection member 32 may be connected to the impact panel 26.

The connection member 32 may be a single tether 56 or may include more than one tether 56, as shown in FIGS. 3-5. In examples where the connection member 32 includes more than one tether 56, the tethers 56 may be spaced from each other, i.e., the tethers 56 may be positioned such that they do not contact each other. The tethers 56 may be made of the same material as the impact panel 26. The tethers 56 are uninflatable and disconnected from the inflation chambers 24 and extension chambers 36

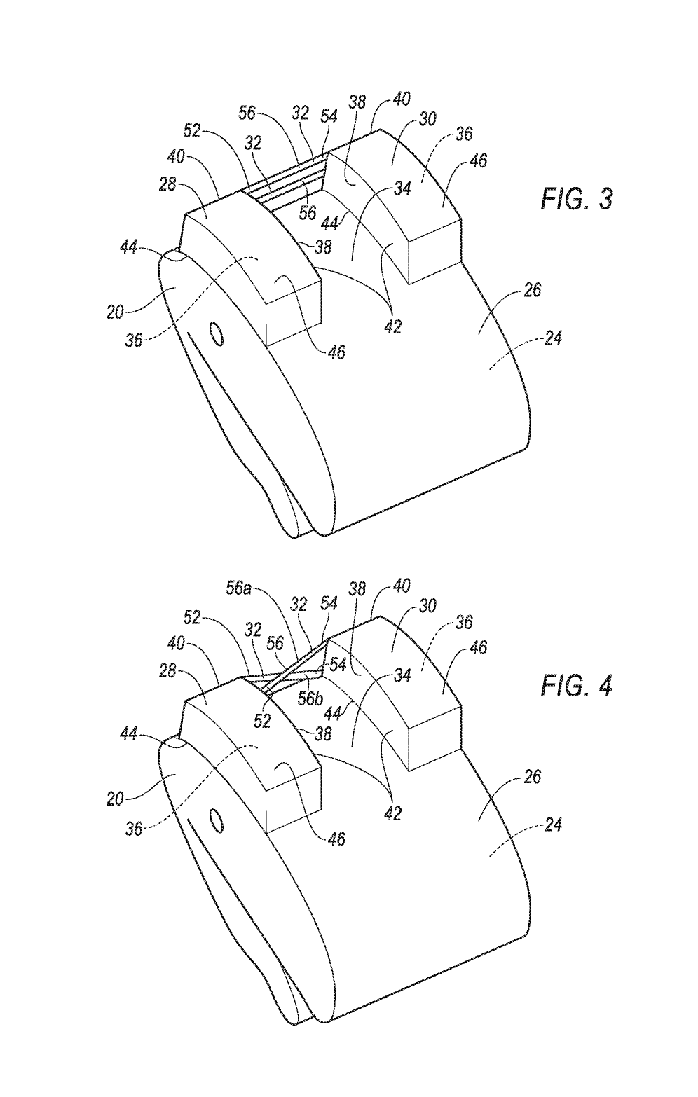

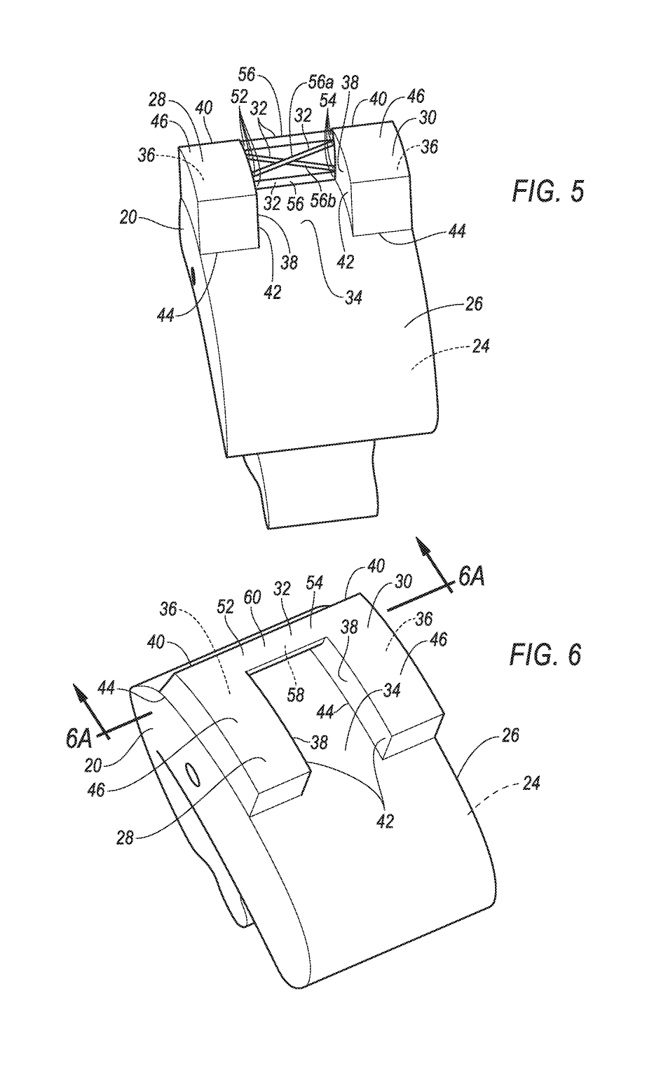

One or more of the tethers 56 extend in parallel with each other and with the face 34. In addition, or in the alternative, one or more of the tethers may extend transversely to the face 34, i.e., may extend from the proximate end 44 of the first extension 28 to the distal end 46 of the second extension 30, as shown in FIGS. 4 and 5. In an example, where the tethers 56 extend transversely to the face 34, the tethers 56 may extend transversely to each other, i.e., may cross, e.g., in an X-shape. For example, with reference to FIG. 4, the connection member 32 may include a first and a second tether 56a, 56b. The first tether 56a may extend from the proximate end 44 of the first extension 28 to the distal end 46 of the second extension 30. The second tether 56b may extend from the distal end 46 of the first extension 28 to the proximate end 44 of the second extension 30.

With reference to FIGS. 6 and 6A, the connection member 32 may define a second inflation chamber 58. The second inflation chamber 58 may be defined by a sheet 60 of material overlapped and secured to itself to enclose the second inflation chamber 58. The second inflation chamber 58 may be formed from, and defined by, one or more of sheets 60 of material secured, e.g., stitched, to each other. The sheet(s) 60 of material forming the second inflation chamber 58 may be the same material as the impact panel 26.

The second inflation chamber 58 is in communication with the inflation chamber 24. Specifically, gases released by the inflator 22 during deployment of the airbag 20 may flow from the inflation chamber 24 to the second inflation chamber 58, e.g., via at least one of the extensions 28, 30. For example, the second inflation chamber 58 may be open to the extensions 28, 30. Alternatively, for example, a vent, e.g., an open vent, a one-way vent, a two-way vent, an active vent, etc., may be disposed in the second inflation chamber 58 at the extensions 28, 30 for controlling gas flow.

As shown in FIGS. 6 and 6A, the second inflation chamber 58 may be spaced from the impact panel 26, i.e., the second inflation chamber 58 may be positioned to be free from contact with the impact panel 26.

With reference to FIGS. 2, 7 and 8, the connection member 32 may be one or more panels 62. The panel 62 is wider than the tether 56 in a direction transverse to the face 34. The panel 62 is uninflatable and disconnected from the inflation chambers 24 and extension chambers 36. The material forming the panel 62 may be of the same type as the impact panel 26.

The panel 62 extends at least part way between the proximate ends 42 and the distal ends 46 of the extensions 28, 30. The panel 62 may extend the entire distance along the extensions 28, 30 between the impact panel 26 and the distal ends 46. The panel 62 may extend part of the distance along the extensions 28, 30 between the impact panel 26 and the distal ends 46. For example, the panel 62 may be spaced from the impact panel 26 and/or the distal ends 46.

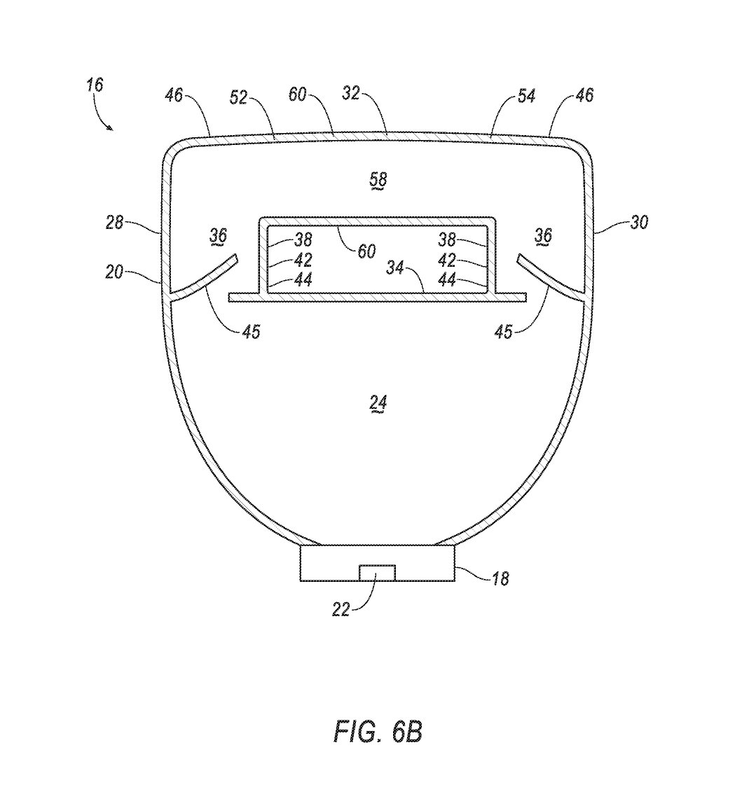

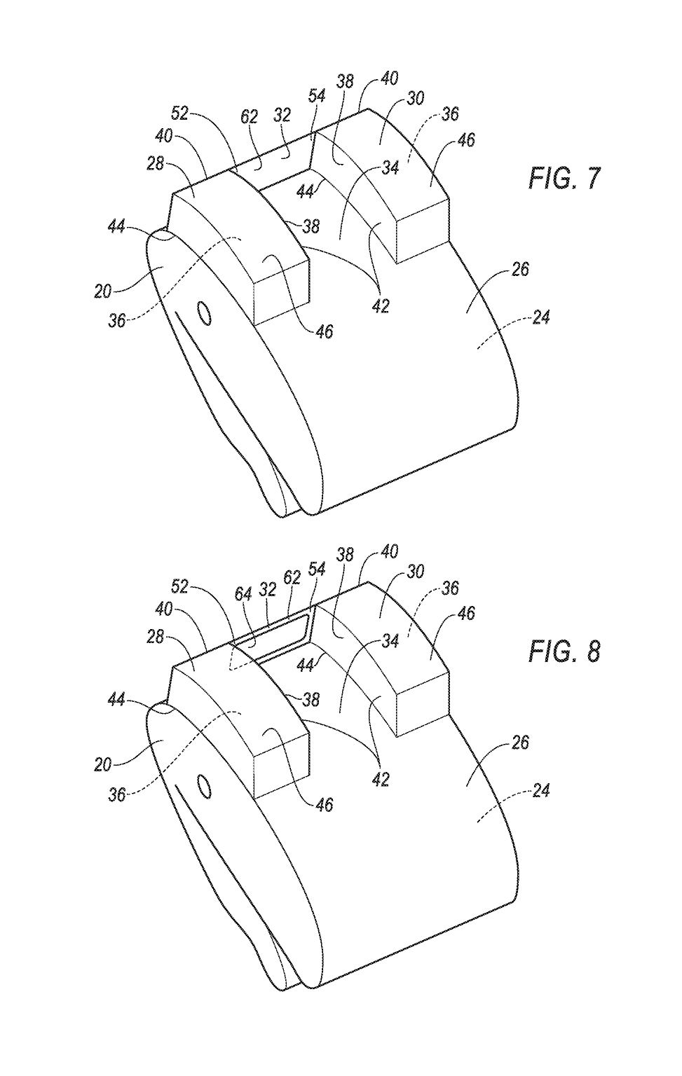

With reference to FIGS. 2 and 7, the panel 62 may be free of openings. As another example, with reference to FIG. 8, the panel 62 may define an opening 64. The opening 64 is completely bordered by the panel 62. The opening 64 may be any number of various shapes, e.g., circular, oval, rectangular, etc.

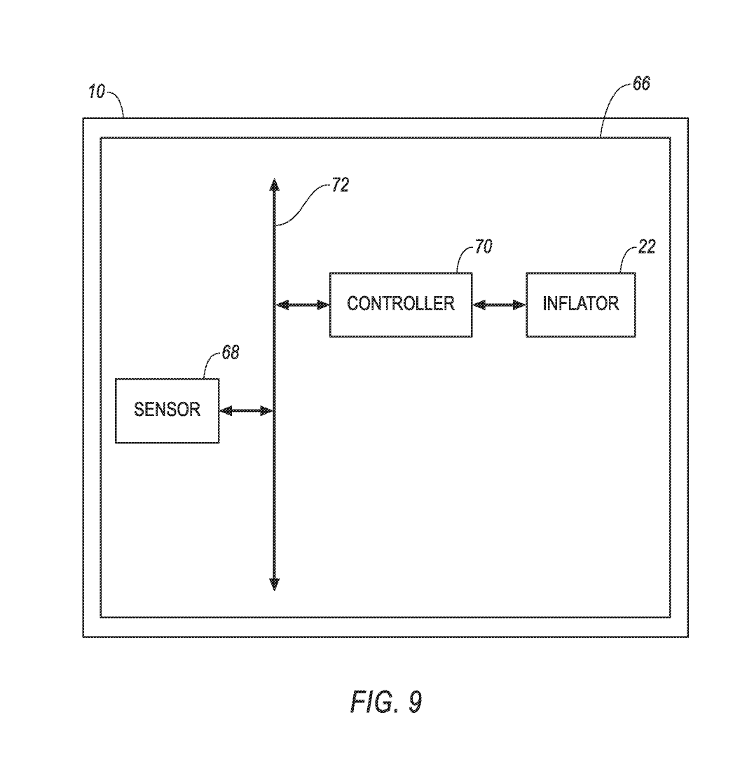

With reference to FIG. 9, the vehicle 10 includes an impact sensing system 66. The impact sensing system 66 may include at least one impact sensor 68 for sensing impact of the vehicle 10, and a controller 70 in communication with the impact sensor 68 and the inflator 22. The controller may activate the inflator 22, e.g., provide an impulse to a pyrotechnic charge of the inflator 22, when the impact sensor 68 senses an impact of the vehicle 10. Alternatively or additionally to sensing impact, the impact sensing system 66 may be configured to sense impact prior to impact, i.e., pre-impact sensing.

The impact sensor 68 may be in communication with the controller 70. The impact sensor 68 is configured to detect an impact to the vehicle 10. The impact sensor 68 may be of any suitable type, for example, post-contact sensors such as accelerometers, pressure sensors, and contact switches; and pre-impact sensors such as radar, LIDAR, and vision-sensing systems. The vision systems may include one or more cameras, CCD image sensors, CMOS image sensors, etc. The impact sensor 68 may be located at numerous points in or on the vehicle 10.

The controller 70 may be a microprocessor-based controller implemented via circuits, chips, or other electronic components. For example, the controller 70 may include a processor, memory, etc. The memory of the controller 70 may include memory for storing instructions executable by the processor as well as for electronically storing data and/or databases.

The inflator 22 is in fluid communication with the airbag 20. Upon receiving a signal, e.g., from the controller 70, the inflator 22 may inflate the airbag 20 with an inflatable medium, such as a gas. The inflator 22 may be, for example, a pyrotechnic inflator that uses a chemical reaction to drive inflation medium to the airbag 20. The inflator 22 may be of any suitable type, for example, a cold-gas inflator.

The controller 70 and the impact sensor 68 may be connected to a communication bus 72, such as a controller area network (CAN) bus, of the vehicle 10. The controller 70 may use information from the communication bus 72 to control the activation of the inflator 22. The inflator 22 may be connected to the controller 70, as shown in FIG. 9, or the inflator 22 may be connected directly to the communication bus 72.

In operation, the airbag 20 is in an uninflated position, as shown in FIG. 1, under normal operating conditions of the vehicle 10. In the event of an impact, the impact sensor 68 may detect the impact and transmit a signal through the communication bus 72 to the controller 70. The controller 70 may transmit a signal through the communication bus 72 to the inflator 22. The inflator 22 may discharge and inflate the airbag 20 with the inflation medium from the uninflated position to the inflated position.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. An airbag comprising:
an impact panel defining an inflation chamber;
a first and a second extension spaced from each other, each extension having a first portion and a second portion extending transversely to the impact panel, the first portions facing each other, and the first portions facing in a direction transverse to the second portions; and
a connection member extending from the second portion of the first extension to the second extension.

2. The airbag of claim 1, wherein the connection member includes a first end secured to the second portion of the first extension and a second end secured to the second extension.

3. The airbag of claim 1, wherein the connection member is spaced from the impact panel.

4. The airbag of claim 1, wherein each of the first and second extension includes a proximate end and a distal end, the connection member extending from the proximate end of the first extension to the distal end of the second extension.

5. The airbag of claim 1, wherein the connection member defines a second inflation chamber in communication with the inflation chamber.

6. The airbag of claim 5, wherein the second inflation chamber is spaced from the impact panel.

7. The airbag of claim 1, wherein the connection member includes at least one tether.

8. The airbag of claim 1, wherein the connection member includes a plurality of tethers.

9. The airbag of claim 8, wherein the tethers are spaced from each other.

10. The airbag of claim 8, wherein the tethers are parallel with each other.

11. The airbag of claim 1, wherein each of the first and second extension includes a proximate end and a distal end, the connection member includes a first and a second tether, the first tether extending from the proximate end of the first extension to the distal end of the second extension, the second tether extending from the distal end of the first extension to the proximate end of the second extension.

12. The airbag of claim 1, wherein each of the first and second extension includes a proximate end and a distal end, the connection member is a panel and extends at least part way between the proximate ends and the distal end of extensions.

13. The airbag of claim 12, wherein the panel is free of openings.

14. The airbag of claim 12, wherein the panel defines an opening.

15. The airbag of claim 1, wherein the connection member is exterior to the inflation chamber.

16. A vehicle comprising:
an impact panel defining an inflation chamber;
a first and a second extension spaced from each other, each extension having a top portion extending from the impact panel transversely to the impact panel; and
a connection member extending from the top portion of the first extension to the second extension.

17. The vehicle of claim 16, wherein each extension has a bottom portion extending from the impact panel transversely to the impact panel, and the top portion is spaced from the bottom portion in a vehicle longitudinal direction.

18. The vehicle of claim 16, wherein each extension has a bottom portion extending from the impact panel transversely to the impact panel, and each extension is elongated between the top portion and the bottom portion.

19. The vehicle of claim 16, wherein each extension includes a bottom portion and an inward facing portion, the inward facing portions facing each other, and the inward facing portions separating the top portions from the bottom portions.

20. The vehicle of claim 16, wherein the connection member is exterior to the inflation chamber.
